(19) United States
(12) Patent Application Publication
(10) Pub. No.: US 2011/0179952 A1
(43) Pub. Date: Jul. 28, 2011

(54) OIL INFUSER AND METERED DISPENSER

(76) Inventor: Robert Radi, La Quinta, CA (US)

(21) Appl. No.: 13/014,658

(22) Filed: Jan. 26, 2011

Related U.S. Application Data
(60) Provisional application No. 61/298,864, filed on Jan. 27, 2010.

(51) Int. Cl. A47J 31/41; A47J 31/00; A47J 31/06

(52) U.S. Cl. 99/289 R; 99/279

(57) ABSTRACT

The present invention provides, in at least one embodiment, an oil infuser and metered dispenser for creating delicious, perfectly seasoned oil entrees. The dispenser comprises an infusing compartment and a filter disposed therein for receiving one or more flavor pods. A pump draws a base oil in the infusing compartment through the filter and flavor pods, and out the filter into a dispensing compartment. The filter prevents particulate matter from being dispensed in the infused oil. A sensor is included for measuring predetermined amounts of infused oil. Various flavored pods are provided for infusing seasoning, herbs, and other flavors into the base oil.

### CROSS REFERENCE TO RELATED APPLICATIONS

This application claims priority under 35 U.S.C. §119(e) to U.S. Provisional Application No. 61/298,864, filed Jan. 27, 2010, and entitled “OIL INFUSER AND METERED DISPENSER,” the disclosure of which is hereby incorporated by reference in its entirety.

### BACKGROUND OF THE INVENTION

1. Field of Invention

The invention relates generally to infused oils and more particularly, to a device for infusing a base oil with seasonings, herbs, or other flavors, and dispensing the infused oil in metered quantities.

2. Description of Related Art

Infusion is used with herbs that dissolve readily in water, or release their active ingredients easily in oil. Quantities of the herb/water or herb/oil mix will vary according to the herb or how strong the infusion is required to be. A common proportion used is one ounce of herb to one pint of liquid. A common example is herbal tea. People sometime drink infusions of this type for pleasure; other times for health. Herbal remedies and herb-infused oils can be prepared using dried herbs, flowers, or berries, infused together with oil or water. The herb/botanical is then removed from the oil and the oil is used in herbalism in those preparations that require short-term infused oils.

Infusion is often accomplished by combining an infusion base liquid, like olive oil, with an herb, and refrigerating the infusion oil. Infused oils are also used for seasonings, like herbs and spices, which magnify a natural flavor of a food making it richer or more delicate, and other seasonings, like black pepper and basil, which transfer some of their flavor to the food.

U.S. Pat. No. 7,213,507 describes an infusion beverage brewing system including a chamber and an infuser. The infuser is positioned in a liquid, such as hot water, and has an infusing chamber for containing infusible materials, such as tea leaves. After a brewing time has elapsed, an individual moves a piston past a perforated wall portion of the infusing chamber, where small apertures prevent the passage of the tea leaves or other infusible material, isolating the infusible material from the liquid.

U.S. Pat. No. 6,726,946 allows a user to store and brew beverages such as tea. The device includes a base container for storing the loose tea leaves prior to brewing. An infuser is removably attached to the base container. The infuser is shaped so that that it may be inverted over a drinking container and receives a predetermined amount of fresh tea leaves to be soaked during the brewing process.

Oil infusion is typically accomplished with herbs and oils in a jar. However, this conventional method ends up dispensing not just the infused oil, but the undesired and unfiltered particles that are in the oils. Also, this process is manual, which is less precise and harder to repeat, and considered very messy.

### SUMMARY OF THE INVENTION

The present invention provides an oil infuser and metered dispenser for creating delicious, perfectly seasoned oil entrees. The dispenser comprises an infusing compartment and a filter disposed therein for receiving one or more flavor pods. A pump draws a base oil in the infusing compartment through the filter and flavor pods, and out the filter into a dispensing compartment (e.g., automatic infrared dispenser). The filter prevents particulate matter from being dispensed in the infused oil.

In an embodiment of the invention, a device comprises: an infusing compartment for holding a base oil; a dispensing compartment for dispensing infused oil; a removable filter disposed inside the infusing compartment, wherein the removable filter is configured to hold one or more flavor pods; and a pump for drawing the base oil into the removable filter, through the one or more flavor pods, and out of the removable filter to create infused oil, and drawing the infused oil into the dispensing compartment. The device may further comprise a meter for dispensing a predetermined amount of infused oil out of the dispensing compartment, tubing, and a clear lid in the infusing compartment. The pump may be powered by batteries. The flavor pods may comprise garlic, rosemary, chipotle, sage, seasoning, or herbs. The device may further comprise an adjuster mechanism for adjusting the predetermined amount of infused oil. The dispensing compartment may be see-through and infused oil may be dispensed in a drizzle or spray.

In another embodiment of the invention, an oil infusion system comprises: a portable countertop oil infusing device, and one or more flavor pods for infusing one or more flavors into a base oil via the portable countertop oil infusing device. The flavor pods may be specially adapted for use in a portable countertop oil infusing device.

In another embodiment of the invention, a device comprises: an infusing compartment comprising a pump, the infusing compartment configured to store a filter with a flavor pod inside and an infusion base liquid; and a dispensing compartment attached to the infusing compartment, the dispensing compartment comprising an adjuster mechanism, a sensor, and a dispensing outlet, wherein the pump draws the infusion base liquid through the flavor pod and the filter and the dispensing compartment dispenses a metered amount of an infused oil using the measuring mechanism, the sensor, and the dispensing outlet. The device may further comprise a meter for dispensing a predetermined amount of infused oil out of the dispensing compartment, tubing, and a clear lid in the infusing compartment. The flavor pods may comprise garlic, rosemary, chipotle, sage, seasoning, or herbs. The device may further comprise an adjuster mechanism for adjusting the predetermined amount of infused oil. The dispensing compartment may be see-through and infused oil may be dispensed in a drizzle or spray.

An advantage of the invention is that it creates infused oils without the mess created by conventional infusion devices. Another advantage of the invention is that the infused oils are created in measurable quantities preventing a user from using too much oil, as the amount of oil can be metered. Yet another advantage of the invention is that permits a user to create infused oils at home thereby eliminating the need to purchase expensive pre-manufactured infused oil. Even if the user already makes infused oil at home, the user will typically have to keep and store many bottles of oil (e.g., 10 bottles) to have all the desired flavors on hand, occupying a significantly larger amount of kitchen storage space than storing the same amount of flavor pods. Further, the user has the ability to experiment with the flavor the oil to match his taste preferences. Also, the infusion is virtually hands free, as the user can have a skillet in one hand and a spatula in the other hand and still be able to dispense oil in the skillet. Lastly, the user can make the oil and have it fresh, as opposed to using oil that was made much earlier.

The foregoing, and other features and advantages of the invention, will be apparent from the following, more particular description of the preferred embodiments of the invention, the accompanying drawings, and the claims.

### BRIEF DESCRIPTION OF THE DRAWINGS

For a more complete understanding of the present invention, and the advantages thereof, reference is now made to the ensuing descriptions taken in connection with the accompanying drawings briefly described as follows:

FIG. 1 illustrates an oil infuser and metered dispenser according to an embodiment of the invention;

FIG. 2 illustrates a fine mesh filter and different flavored pods for use in the oil infuser of FIG. 1; and

FIG. 3 illustrates the oil infuser of FIG. 1 with the filter placed inside an infusing compartment.

### DETAILED DESCRIPTION OF EMBODIMENTS

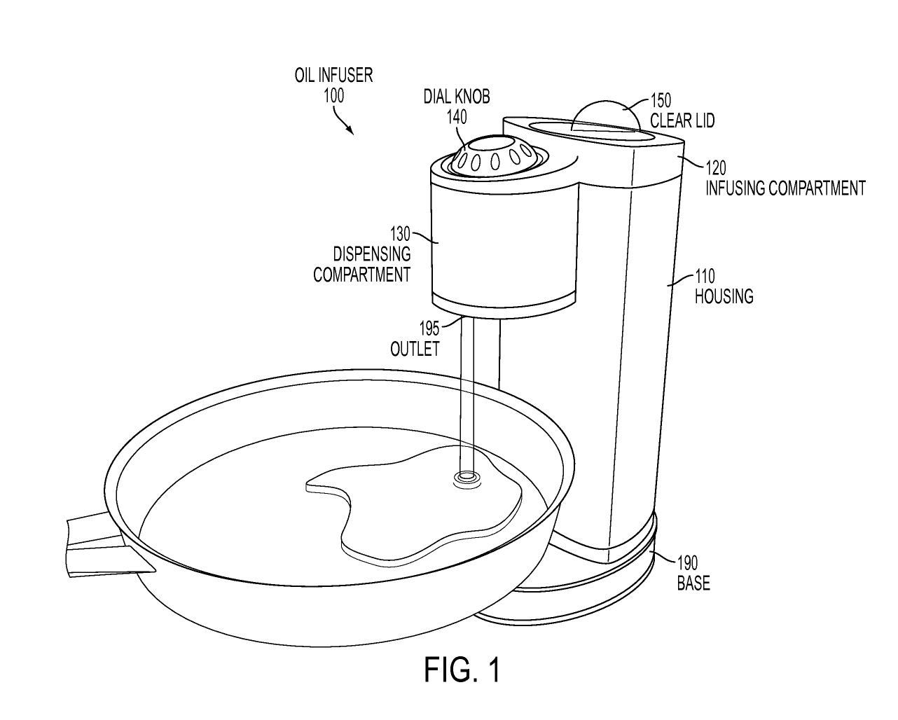

Further features and advantages of the invention, as well as the structure and operation of various embodiments of the invention, are described in detail below with reference to the accompanying FIGS. 1-3, wherein like reference numerals refer to like elements. Although the invention is described in the context of a convenient home countertop appliance for infusing oil, the invention is applicable to other non-oil liquids, e.g., water that can be infused with substances, and may be increased in scale as larger commercial and industrial appliances.

In an embodiment, the present invention provides an oil infuser and metered dispenser for creating delicious, perfectly seasoned oil entrees. The dispenser comprises an infusing compartment and a filter disposed therein for receiving one or more flavor pods. A pump draws a base oil in the infusing compartment through the filter and flavor pods, and out the filter into a dispensing compartment. The filter prevents particulate matter from being dispensed in the infused oil. A sensor is included for measuring predetermined amounts of infused oil. Various flavored pods are provided for infusing seasoning, herbs, and other flavors into the base oil.

FIG. 1 illustrates an oil infuser and metered dispenser 100 according to an embodiment of the invention. The oil infuser 100 comprises a housing 110 for enclosing the internal components of the infuser. In an exemplary configuration, the housing 110 includes an infusing compartment 120 and a dispensing compartment 130. A dial-knob 140 (e.g., adjuster mechanism) is disposed on the dispensing compartment 130 and adjusts an amount of dispensed oil to a number of predetermined amounts through use of an internal automatic infrared sensor (not shown) to regulate quantity (e.g., 1 tablespoon, 2 tablespoons, 3 tablespoons, etc.). However, other types of sensors can be used to measure the dispensed liquid, the identification and implementation of which is apparent to one of ordinary skill in the art. The dispensing compartment 130 includes an outlet 195 (e.g., dispensing outlet) where the infused oil is dispensed into a suitable receptacle such as a pan as shown underneath the dispensing compartment 130. The infused oil can be dispensed in a drizzle, spray, or any other pattern. Other receptacles can include a container, vessel, skillet, hand, glass, etc. In one embodiment, the infusing compartment 120 includes a clear lid 150 (e.g., see thru lid) permitting a user to see inside the compartment when the lid is closed. The clear lid 150 allows the user to see the oil level, among other purposes, such as seeing if the infusing compartment 120 has flavor pods inside. In another embodiment, the infusing compartment 120 is clear such that the user can easily see inside. A base 190 is where batteries (not shown) are housed. The batteries power the pump that draws infused oil out of the infusing compartment 120 into the dispensing compartment 130. One of ordinary skill in the art appreciates that the batteries can be replaced with a power adapter for receiving electrical energy from, for example, an electrical wall socket.

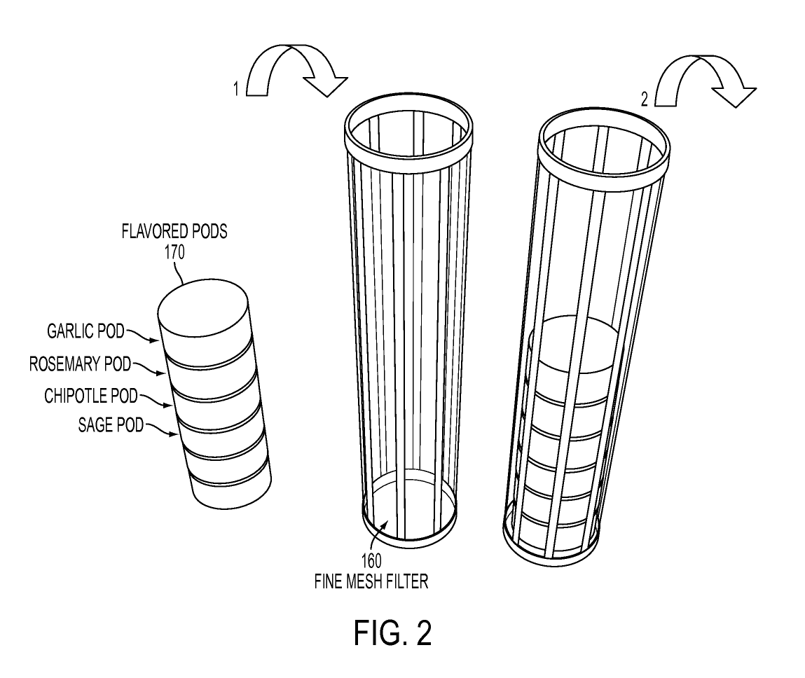

FIG. 2 illustrates a fine mesh filter 160 and different flavored pods 170 (e.g., aromatic pods refills, favorite herbs, etc.) for use in the oil infuser 100. In operation, one or more flavored pods 170 are first inserted into the mesh filter 160, which is then placed inside the infusing compartment 120, which is filled with a base oil. A pump (not shown) draws the base oil into the mesh filter 160, then through the flavored pods 170 in order to infuse one or more flavors into the base oil, and then out through mesh filter 160 and into the dispensing compartment 130. The mesh filter 160 prevents particulate matter in the pods 170 from being dispensed with the infused oil.

The base oil can be any type of edible or cooking oil, which is preferably liquid at room temperature. Exemplary edible vegetable oils include, but are not limited to olive oil, palm oil, soybean oil, canola oil, pumpkin seed oil, corn oil, sunflower oil, safflower oil, peanut oil, grape seed oil, sesame oil, argan oil and rice bran oil. Many other kinds of vegetable oils are also used for cooking. In an embodiment of the invention, the device 100 further comprises a heater (not shown) for decreasing the viscosity of the base oil, particularly in the case of saturated oils such as coconut oil.

Each flavored pod 170 may include one or more seasonings, flavors, or herbs. The pods can be herbs chosen by the user or herbs filled into manufactured tea bag like pouches. Exemplary seasonings and herbs (or flavors) include, but are not limited to garlic, rosemary, chipotle, sage, salt, pepper, basil, chopped peppers, paprika, curry, cayenne, mixed spices, vinegar, orange, lemon, onion, chives, horseradish, mustard, capers, chilis, and any combination thereof.

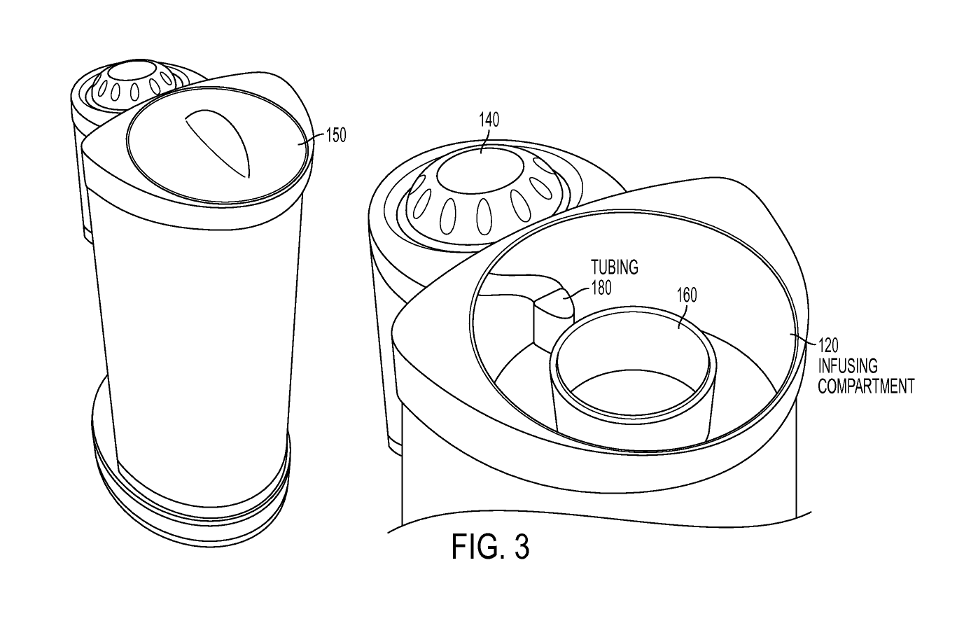

FIG. 3 illustrates the oil infuser 100 with the filter 160 placed inside the infusion compartment 120. Tubing 180 is coupled to the pump (not shown) and draws infused oil into the dispensing compartment 130. The dispensing compartment 130 includes a sensor (not shown), which can be an infrared beam or similar sensor, the identification and implementation of which are apparent to one of ordinary skill in the art. When the container is placed underneath the dispensing compartment 130, the pump is activated and will dispense a preset amount of infused oil. In an alternative embodiment of the invention, the base of the device (in the area directly opposite to the dispensing compartment 130) could have an embedded pressure sensitive switch (not shown), the implementation of which is apparent to one of ordinary skill in the art. The pressure exercised onto the switch will activate the pump hence dispensing the infused oil.

In another embodiment of the invention, the device 100 can be used for cosmetic purposes, e.g., to infuse oils and other liquids for massage, aroma therapy, skin and hair care with other aromatic substances such as herb and flowers.

It is to be recognized that depending on the embodiment, certain acts or events of any of the methods described herein can be performed in a different sequence, may be added, merged, or left out altogether (for example, not all described acts or events are necessary for the practice of the method). Moreover, in certain embodiments, acts or events may be performed concurrently, rather than sequentially.

The invention has been described herein using specific embodiments for the purposes of illustration only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following claims.

I claim:

1. A device comprising:
an infusing compartment for holding a base oil;
a dispensing compartment for dispensing infused oil;
a removable filter disposed inside the infusing compartment, wherein the removable filter is configured to hold one or more flavor pods; and
a pump for drawing the base oil into the removable filter, through the one or more flavor pods, and out of the removable filter to create infused oil, and drawing the infused oil into the dispensing compartment.

2. The device of claim 1, further comprising a meter for dispensing a predetermined amount of infused oil out of the dispensing compartment.

3. The device of claim 1, further comprising tubing in the infusing compartment.

4. The device of claim 1, further comprising a clear lid in the infusing compartment.

5. The device of claim 1, wherein the pump is powered by batteries.

6. The device of claim 1, wherein the flavor pods comprises garlic, rosemary, chipotle, or sage.

7. The device of claim 1, wherein the flavor pods contain seasoning or herbs.

8. The device of claim 1, further comprising an adjuster mechanism for adjusting the predetermined amount of infused oil.

9. The device of claim 1, wherein the dispensing compartment is see-through.

10. The device of claim 1, wherein infused oil is dispensed in a drizzle or spray.

11. An oil infusion system comprising:
a portable countertop oil infusing device, and
one or more flavor pods for infusing one or more flavors into a base oil via the portable countertop oil infusing device.

12. The oil infusion system of claim 11, wherein the flavor pods are specially adapted for use in a portable countertop oil infusing device.

13. A device comprising:
an infusing compartment comprising a pump, the infusing compartment configured to store a filter with a flavor pod inside and an infusion base liquid; and
a dispensing compartment attached to the infusing compartment, the dispensing compartment comprising an adjuster mechanism, a sensor, and a dispensing outlet, wherein the pump draws the infusion base liquid through the flavor pod and the filter and the dispensing compartment dispenses a metered amount of an infused oil using the measuring mechanism, the sensor, and the dispensing outlet.

14. The device of claim 13, further comprising a meter for dispensing a predetermined amount of infused oil out of the dispensing compartment.

15. The device of claim 13, further comprising tubing in the infusing compartment.

16. The device of claim 13, further comprising a clear lid in the infusing compartment.

17. The device of claim 13, wherein the flavor pods comprises garlic, rosemary, chipotle, or sage.

18. The device of claim 13, wherein the flavor pods contain seasoning or herbs.

19. The device of claim 13, wherein the dispensing compartment is see-through.

20. The device of claim 13, wherein infused oil is dispensed in a drizzle or spray.
